(19) United States
(12) Patent Application Publication
(10) Pub. No.: US 2023/0270082 A1
(43) Pub. Date: Aug. 31, 2023

(54) SYSTEM AND PROCESS FOR RECYCLING BIOGENIC CARBON DIOXIDE

(71) Applicants: Terje Ernst MIKALSEN, Osteras (NO); JOHANNESSEN Arild, Sandnes (NO); Gas 2 Feed AS, Farsund (NO)

(72) Inventors: Terje Ernst MIKALSEN, Sandnes (NO); Arild JOHANNESSEN, Osteras (NO)

(21) Appl. No.: 18/007,355

(22) PCT Filed: Apr. 28, 2021
(86) PCT No.: PCT/IB2021/000291

§ 371 Date: Jan. 30, 2023

(30) Foreign Application Priority Data
Apr. 28, 2020 (NO) 20200501

(51) Int. Cl. A01K 63/04; C02F 1/461; C02F 1/72; C02F 1/20; C02F 9/00; C02F 3/02

(52) U.S. Cl. CPC A01K 63/04; C02F 1/20; C02F 1/461; C02F 1/727; C02F 3/02; C02F 9/00; C02F 2103/20

(57) ABSTRACT

The present disclosure provides systems and processes for recycling biogenic CO₂. A system includes an aquacultural reservoir (102) configured to contain water (108) and aquatic animals (110) that live therein; a separation stage (104) in fluid communication with the aquacultural reservoir, wherein the separation stage is configured to receive water from the aquacultural reservoir and separate biogenic CO₂ gas (114) from the water; and a fermentation tank (106) in gas communication with the separation stage, wherein the fermentation tank is configured to receive and convert the biogenic CO₂ into biomass (126) by fermentation. The produced biomass can be used to cultivate the aquatic animals in the aquacultural reservoir.

### CROSS-REFERENCE TO RELATED APPLICATION(S)

This application is being filed on Apr. 28, 2021, as a PCT International Patent Application and claims priority to Norwegian Patent Application No. 20200501, filed on Apr. 28, 2020, titled “PROCESS FOR PRODUCING BIOMASS FOR FISH FEED THROUGH DIRECT USE OF CARBON DIOXIDE FROM FARMING AQUATIC ORGANISMS AND THE ELECTROLYSIS OR WATER,” which is hereby incorporated by reference in its entirety.

### BACKGROUND

With numerous detrimental effects of greenhouse gases being increasingly documented, there is a clear need to control or reduce emission of greenhouse gases. It is often beneficial to recycle and renew greenhouses gases before they are released to natural atmosphere. Carbon dioxide (CO₂) is a known class of greenhouse gas, and uncontrolled emission of CO₂ has become a significant environmental challenge. A primary source of CO₂ emission is the CO₂ biogenically produced by living organisms through metabolism and exhalation. Particularly in aquacultural industry, large quantities of biogenic CO₂ are produced by fish and other aquatic animals in farming plants and contribute substantially to CO₂ emission. The biogenic CO₂ is typically dissolved and stored in water. The aquacultural water rich in biogenic CO₂ is usually treated as an organic waste and directly released to the environment without further processing. Consequently, the biogenic CO₂ carried by aquacultural water is uncontrollably released to the natural atmosphere and contributes to the climate challenge. Unfortunately, emission of biogenic CO₂ from aquatic water has been significantly neglected or under-addressed by the society. In addition, biogenic CO₂ dissolved in aquacultural water, if not timely removed, could affect the water quality and pH balance, which in turn could harm the health of living animals therein. Thus, it is highly desirable to remove CO₂ from aquacultural water and prevent or reduce emission of biogenic CO₂ based on both economic and environmental considerations.

US 2013/0112151 discloses a breeding system for aquatic animals. The disclosed system allegedly can remove CO₂ from the water and to supply oxygen to the water to sustain the living conditions for the aquatic animals. JP 2003259759 discloses a system for removing CO₂ from an aquaculture plant while supplying oxygen. However, these systems are intended only for cultivating and breeding purposes.

WO 2018/070878 discloses a fish farming system that could capture CO₂ produced by aquatic animals from cultivating/breeding plants by CO₂ extraction. This process, however, is only arranged to chemically convert the extracted CO₂ to methane and methanol. It is well known that methane and methanol are only intermediates for the production of fish feed and cannot be directly consumed by aquatic animals. Conversion of methane and methanol to fish feed that are ultimately consumable not only requires additional processing but also incurs significant loss of the captured carbon. It is thus highly desirable for an aquacultural farming system that can both recycle biogenic CO₂ and directly convert the recycled CO₂ into consumable fish feed with improved efficiency and reduced carbon loss.

### SUMMARY

In general terms, this disclosure is directed to aquacultural systems and processes. In one possible configuration and by non-limiting example, a system for recycling or reusing biogenic CO₂ is disclosed. Various aspects are described in this disclosure, which include, but are not limited to, the following aspects.

One aspect is a system comprising an aquacultural reservoir arranged and configured to contain water and aquatic animals that live therein; a separation stage in fluid communication with the aquacultural reservoir; and a fermentation tank in gas communication with the separation stage. The separation stage is arranged and configured to receive water from the aquacultural reservoir and separate gas from the water to generate CO₂-poor water and a gas comprising biogenic CO₂ that is generated by aquatic animals therein. The fermentation tank is arranged and configured to receive the gas from the separation stage and cultivate bacteria by biosynthetically converting the biogenic CO₂ of the gas into biomass.

Another aspect is the system, wherein the system includes an electrolysis stage in gas communication with the fermentation tank, and wherein the electrolysis stage is arranged and configured to electrolyze water and produce gaseous hydrogen (H₂), oxygen (O₂), and heated water, and wherein the fermentation tank is arranged and configured to receive at least a portion of the H₂ from the electrolysis stage; to combine the H₂ and the biogenic CO₂; and to cultivate bacteria by biosynthetically converting the combined gases to biomass.

A further aspect is the system, wherein the fermentation tank is arranged and configured to receive at least a portion of the O₂ from the electrolysis stage; to combine the H₂, the O₂, and the biogenic CO₂; and to cultivate bacteria by biosynthetically converting the combined gases to biomass.

Yet another aspect is the system, wherein the system includes a controller arranged and configured to adjust the ratio of the H₂, the O₂, and the biogenic CO₂ being received by the fermentation tank.

Another aspect is the system, wherein the electrolysis stage is in gas communication with the aquacultural reservoir, and wherein the cultivation stage is arranged and configured to receive at least a portion of the O₂ generated in the electrolysis stage.

A further aspect is the system, wherein the system comprises an oxygenation tank in fluid communication with the separation stage and in gas communication with the electrolysis stage, wherein the oxygenation tank is arranged and configured to receive the CO₂-poor water from the separation stage; to receive at least a portion of the O₂ from the electrolysis stage; to oxygenate the CO₂-poor water with the O₂, and to form O₂-rich water.

Yet another aspect is the system, wherein the oxygenation tank is in fluid communication with the aquacultural reservoir, and wherein the aquacultural reservoir is arranged and configured to receive the O₂-rich water from the oxygenation tank.

A further aspect is the system, wherein the system includes a heat pump in fluid communication with the electrolysis stage, wherein the heat pump is arranged and configured to receive and heat the heated water from the electrolysis stage to produce hot water or steam.

Yet another aspect is the system, wherein the system comprises a fertilizer plant arranged and configured to receive the hot water or steam produced by the heat pump, wherein the hot water or steam is used for drying sludge or producing fertilizer in the fertilizer plant.

Another aspect is the system, wherein the system includes a treatment plant arranged and configured to receive the hot water or steam produced by the heat pump, wherein the hot water or steam is used for slaughtering, food processing, sanitation, and treatment of meat products in the treatment plant.

A further aspect is the system, wherein the system includes a heat exchanger in fluid communication with the electrolysis stage, wherein the heat exchanger is arranged and configured to: receive the heated water from the electrolysis stage; extract the heat energy from the heated water; and produce cooled water.

Yet another aspect is the system, wherein the extracted heat energy of the heated water is transferred to a fertilizer plant and used for drying sludge or producing fertilizer in the fertilizer plant.

Another aspect is the system, wherein the extracted heat energy of the heated water is transferred to a treatment plant and used for slaughtering, food processing, sanitation, and treatment of meat products in the treatment plant.

A further aspect is the system, wherein the extracted heat energy of the heated water is supplied to the aquacultural reservoir and used for regulating the temperature of the aquatic water therein.

Yet another aspect is the system, wherein the extracted heat energy of the heated water is supplied to the separation stage and used for regulating the temperature of the water therein.

A further aspect is the system, wherein the extracted heat energy of the heated water is supplied to the fermentation tank and used for regulating the temperature thereof.

A further aspect is the system, wherein the system includes a formulation plant arranged and configured to produce aquatic feed using the biomass produced in the fermentation tank, and wherein the aquatic feed is directly or indirectly transported to the aquacultural reservoir for feeding aquatic animals therein.

Another aspect is the system, wherein the cooled water produced by the heat exchanger is recycled as feed water for electrolysis.

A further aspect is the system, wherein the system includes a dryer arranged and configured to receive and dry the biomass produced in the fermentation tank.

Yet another aspect is the system, wherein the system includes a formulation plant arranged and configured to produce aquatic feed using the biomass produced in the fermentation tank, and wherein the aquatic feed is directly or indirectly used to feed aquatic animals in the aquacultural reservoir.

Another aspect is the system, wherein the electrolysis stage is in fluid communication with the fermentation tank, wherein the electrolysis stage is arranged and configured to receive and electrolyze water generated from the bacteria cultivation in the fermentation tank.

A further aspect is the system, wherein the aquacultural reservoir is a closed or substantially closed cultivation or breeding tank.

Yet another aspect is the system, wherein the aquacultural reservoir contains salmon.

In another possible configuration and by non-limiting example, a process for recycling and reusing biogenic CO₂ is disclosed. Various aspects are described in this disclosure, which include, but are not limited to, the following aspects.

One aspect is a process comprising collecting aquatic water containing biogenic CO₂ from an aquacultural reservoir; separating gas from the aquatic water in a separation stage to form a gas containing the biogenic CO₂, and CO₂-poor water; transporting the gas to a fermentation tank containing bacteria; and cultivating the bacteria by biosynthetically converting the biogenic CO₂ to biomass.

Another aspect is the process, where the process includes electrolyzing water in a n electrolysis stage to generate gaseous O₂ and H₂, and heated water; transporting at least a portion of the H₂ and at least of a portion of the O₂ into the fermentation tank; combing the H₂, the O₂, and the biogenic CO₂ in the fermentation tank; and cultivating the bacteria by biosynthetically converting combined gases to biomass.

A further aspect is the process, wherein the process includes adjusting the ratio of the H₂, the O₂, and the biogenic CO₂ being received in the fermentation tank.

Yet another aspect is the process, wherein the process includes transporting at least a portion of the O₂ gas generated in the electrolysis stage into the aquacultural reservoir to provide oxygen for aquatic animals therein.

Another aspect is the process, wherein the process includes transporting at least a portion of the O₂ gas into an oxygenation tank; transporting the CO₂-poor water into the oxygenation tank; oxygenating the CO₂-poor water with the O₂ to form O₂-rich water; and transporting the O₂-rich water into the aquacultural reservoir.

A further aspect is the process, wherein the process includes removing the produced biomass from the fermentation plant; collecting and drying the removed biomass in a dryer; transporting the dried biomass into a formulation plant; and producing aquatic feed in the formulation plant.

Yet another aspect is the process, wherein process includes feeding aquatic animals in the aquacultural reservoir with the produced aquatic feed.

Another aspect is the process, wherein the process includes passing the heated water generated from the electrolyzing water through a heat exchanger to produce heat and cooled water; recycling the cooled water; and using the produced heat for aquacultural purposes.

A further aspect is the process, wherein the process includes passing the heated water generated from the electrolyzing water through a heat pump to produce hot water or steam; and using the hot water or steam for aquacultural purposes.

In another possible configuration and by non-limiting example, a closed farming system. Various aspects are described in this disclosure, which include, but are not limited to, the following aspects.

One aspect is a closed farming system comprising an aquacultural reservoir arranged and configured to contain water and aquatic animals that live therein; a separation stage in fluid communication with the aquacultural reservoir, wherein the separation stage is arranged and configured to receive water from the aquacultural reservoir and to separate gas from the water to form a gas comprising biogenic CO₂, and CO₂-poor water; an electrolysis stage arranged and configured to electrolyze water and to produce gaseous H₂ and O₂; a fermentation tank in gas communication with the separation stage and the electrolysis stage, and a controller, wherein the fermentation tank is arranged and configured to: receive the gas from the separation stage, and at least a portion of the H₂ and at least a portion of the O₂ from the electrolysis stage; combine the gases; and cultivate bacteria by biosynthetically converting the combined gases into biomass, wherein the controller is arranged and configured to adjust the ratio of H₂/O₂/CO₂ being received by the fermentation tank, and wherein the produced biomass is directly or indirectly used to feed aquatic animals in the aquacultural reservoir.

Another aspect is the closed farming system, wherein the electrolysis stage is in gas communication with the aquacultural reservoir, and wherein the cultivation stage is arranged and configured to receive at least a portion of the O₂ from the electrolysis stage.

A further aspect is the closed farming system, wherein the system includes an oxygenation tank respectively in fluid communication with the separation stage, in fluid communication with the aquacultural reservoir, and in gas communication with the electrolysis stage, wherein the oxygenation tank is arranged and configured to: receive the CO₂-poor water from the separation stage; receive at least a portion of the gaseous O₂ from the electrolysis stage; and oxygenate the CO₂-poor water with the O₂ to form O₂-rich water, and wherein the aquacultural reservoir is arranged and configured to receive the O₂-rich water.

Yet another aspect is the closed farming system, wherein the system includes a heat pump in fluid communication with the electrolysis stage, wherein the heat pump is arranged and configured to receive and heat the heated water from the electrolysis stage to produce hot water or steam.

Another aspect is the closed farming system, wherein the system includes a heat exchanger in fluid communication with the electrolysis stage, wherein the heat exchanger is arranged and configured to receive the heated water from the electrolysis stage; extract the heat energy from the heated water; and produce cooled water.

A further aspect is the closed farming system, wherein the system is substantially self-sustaining.

### BRIEF DESCRIPTION OF THE DRAWINGS

FIG. 1 illustrates a schematic view of a first example system for recycling and reusing biogenic CO₂.

FIG. 2 illustrates a schematic view of a second example system for recycling and reusing biogenic CO₂.

FIG. 3 illustrates a schematic view of a third example system for recycling and reusing biogenic CO₂.

FIG. 4 illustrates a schematic view of a fourth example system for recycling and reusing biogenic CO₂.

FIG. 5 illustrates a flow diagram of a first example process for recycling and reusing biogenic CO₂.

FIG. 6 illustrates a flow diagram of a second example process for recycling and reusing biogenic CO₂.

FIG. 7 illustrates a flow diagram of a third example process for recycling and reusing biogenic CO₂.

FIG. 8 illustrates an example operation for processing the biomass according to FIGS. 5-7.

FIG. 9 illustrates a first example operation for processing the heated water according to FIG. 7.

FIG. 10 illustrates a second example operation for processing the heated water according to FIG. 7.

### DETAILED DESCRIPTION

Various embodiments will be described in detail with reference to the drawings, wherein like reference numerals represent like parts and assemblies. Reference to various embodiments does not limit the scope of the claims attached hereto. Additionally, any examples set forth in this specification are not intended to be limiting and merely set forth some of the many possible embodiments for the appended claims.

The present disclosure relates to systems and processes that can be used to recycle or reuse biogenic CO₂ generated by aquatic animals and dissolved or stored in water. The systems and processes disclosed herein are particularly useful in aquacultural industry such as fish farming plants.

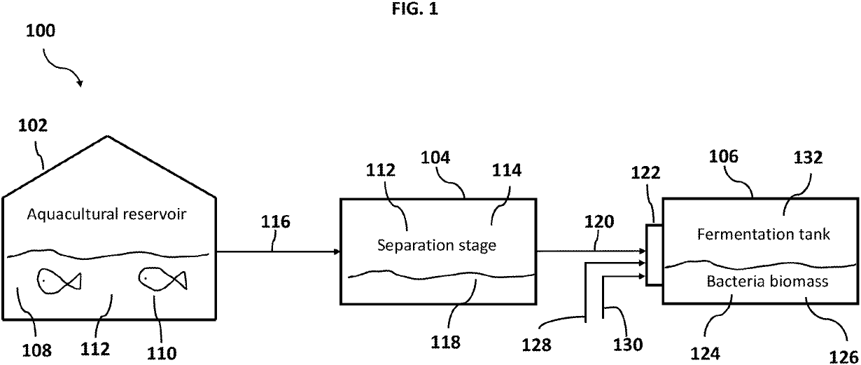

Now referring to FIGS. 1-4, exemplary examples of systems for recycling biogenic CO₂ will be described. FIG. 1 is a schematic view of a first example system 100 for recycling and reusing biogenic CO₂. In the illustrated example, the system 100 includes an aquacultural reservoir 102, a separation stage 104, and a fermentation tank 106. The systems according to the present disclosure may be closed or substantially closed. In a closed or a substantially closed system, gas leakage is minimized, and biogenic CO₂ generated in the system is prevented from emitting into the environment. In some embodiments, the system 100 is a closed or substantially closed system, wherein each of the components of the system 100 is in either fluid communication or gas communication or in both fluid and gas communication with the other components. The aquacultural reservoir 102 may be a typical land-based breeding or cultivating container such as a closed or substantially closed cultivating tank or alternatively, an open pond.

The aquacultural reservoir 102 is arranged and configured to contain aquatic water 108 and living organisms 110 therein. The aquatic water 108 contains biogenic CO₂ 112 that is dissolved or stored in the water. The biogenic CO₂ 110 is produced by the living organisms 110 through metabolism. In some embodiments, the aquacultural reservoir 102 is a closed cultivating tank, which may be free or substantially free of CO₂ from external sources. A closed cultivation tank has several advantages. For example, environmental impact is minimal due to prevention and/or treatment of diseases and parasites (e.g. salmon lice), prevention of escape, relatively easy medication in a closed cultivation tank compared with an open system. Further, removal of waste such as feces, dead animals, over-feedings is more efficient in closed cultivation or breeding systems. However, in a closed cultivation tank, biogenic CO₂ should be removed from water for maintaining acceptable pH values. The biogenic CO₂ is also considered as a waste product with negative environmental effects such as acidification of the water through the formation of H₂CO₃ and HCO₃⁻. A substantially high content of CO₂ in the water will also cause it difficult for aquatic animals to “breathe” because the water becomes CO₂-poisoned.

The living organisms 110 in the aquacultural reservoir 102 broadly encompass any fish or aquatic animals that are beneficial or of economic value. The living organisms 110 include but are not limited to carp, mullet, bass, abbor, pike, trout, salmon, or any combinations thereof. A particular example of the aquatic animal is salmon. The aquatic water 108 used for cultivating and/or breeding the aquatic animals may be salt or fresh appropriate for the aquatic animals therein. In some embodiments, fresh water is preferred. Examples of the living organisms 110 that are thriving in fresh water other than fish, and that may be cultivated in a land-based closed cultivation and/or breeding tank either alone or together with the different fish types, may be fresh water crawfish, fresh water clams, pearl fresh water oysters, etc.

The aquacultural reservoir 102 is in fluid communication with the separation stage 104. In some embodiments, the aquacultural reservoir 102 and the separation stage 104 are connected by one or more connecting lines 116, wherein the aquatic water 108 containing the biogenic CO₂ 110 can be transported through the connecting lines 116 to the separation stage 104. In some embodiments, one or more pumps (not shown) in connection to the connecting lines 116 can be used to facilitate the transportation of the aquatic water. The flow rate of water may be controlled by a liquid flow meter/controller (not shown) commonly known in the art.

The separation stage 104 is arranged and configured to receive the aquatic water 108. The separation stage 104 includes a means to separate biogenic CO₂ 112 from the aquatic water 108 in the separation stage 104. Upon separation, a gas 114 is generated and sequestered or separated from the resulted CO₂-poor water 118. The gas 114 comprises primarily the biogenic CO₂ 112 that has been dissolved in the aquatic water 108. In some embodiments, the gas 114 is a mixture of the biogenic CO₂ 112 and other gaseous species like O₂ that is originally from the aquacultural reservoir. The means to separate biogenic CO₂ 112 from the aquatic water 108 may employ state of the art techniques such as membrane extraction, aeration through pressure reduction, or by using ultrasound waves for forming CO₂ bubbles, etc. In some embodiments, the separation stage 104 includes one or more ultrasound generators (not shown) arranged and configured to evacuate the gas 114 or the biogenic CO₂ 112 from the aquatic water. Other exemplary examples of CO₂ extraction include Supercritical Fluid Extraction Systems (FES) supplied by Waters Corporation (Milford, MA). In some embodiments, the gas 114 may be harvested and accumulated in the separation stage 104. Alternatively, in other embodiments, the gas 114 may be continuously removed from the separation stage 104 or transported to other components of the system 100 without being accumulated in the separation stage 104.

In some embodiment, all or nearly all of the biogenic CO₂ dissolved in the aquatic water is separated therefrom in the separation stage 104. In other embodiments, not all biogenic CO₂ is separated from the aquatic water in the separation stage 104, and the CO₂-poor water 118 may still contain a detectable amount of CO₂. The separation efficiency may be controlled to appropriate levels for the purposes of operation efficiency and energy/cost saving. It is noted that although excess CO₂ in the aquatic water 108 is harmful to the living organism, a balanced level of CO₂ may be acceptable. The system 100 thus advantageously provides a solution to controlling the level of CO₂ in the aquatic water of the aquacultural reservoir.

The separation stage 104 is in gas communication with the fermentation tank 106. In some embodiments, the separation stage 104 and the fermentation tank 106 are connected by one or more connecting lines 120, wherein the gas 114 containing the biogenic CO₂ 112 can be transported through the connecting lines 120 to the fermentation tank 106. In some embodiments, one or more pumps (not shown) in connection to the connecting lines 120 can be used to facilitate the transportation of the gas 114. The flow rate of gas may be controlled by a gas mass meter/controller (not shown) commonly known in the art.

The fermentation tank 106 is arranged and configured to receive the gas 114 generated in the separation stage 104 and to biosynthetically convert the biogenic CO₂ 112 contained in the gas 114 to biomass through gas fermentation. In some embodiments, the fermentation tank 106 contains microorganisms or microbial culture 124 that capable of utilizing the biogenic CO₂ 112 as carbon source to produce a biomass 126 through fermentation or gas fermentation processes. In some embodiments, the biomass 126 is rich in protein. Examples of the microorganisms or microbial culture 124 include yeast, fungus, algae, archaeon, bacterium, or mammal cells.

As an exemplary example, the microbial culture 124 comprises knallgas microorganisms selected from the group consisting of the following genera:

Acidithiobacillus sp.; Acidovorax sp.; Alcaligenes sp.; Anabaena sp.; Ankistrodesmus sp.; Aquificae sp.; Bradyrhizobium sp.; Chlamydomonas sp.; Cupriavidus sp.; Derxia sp.; Flavobacteriae sp.; Gordonia sp.; Helicobacter sp.; Hydrogenobacter sp.; Hydrogenomonas sp.; Hydrogenophaga sp.; Hydrogenothermaceae sp.; Hydrogenovibrio sp.; Mycobacteria sp.; Nocardia sp.; Pseudomonas sp.; Ralstonia sp.; Renobacter sp.; Rhaphidium sp.; Rhizobium sp.; Rhodococcus sp.; Thiocapsa sp.; Variovorax sp.; Xanthobacter sp.; and combinations thereof.

In some embodiments, the fermentation tank 106 is arranged and configured to receive input H₂ gas 128 from either an internal component of the system 100 or external sources. The fermentation tank 106 is arranged and configured to mix the input H₂ with the biogenic CO₂ 112 to form a combined gas 132 comprising H₂ and CO₂. In some embodiments, the system 100 includes a controller (not shown) arranged and configured to adjust the ratio of H₂/CO₂ of the combined gas 132 to a level desirable for promoting bacteria growth when operating. The system 100 may optionally include a pressure controller (not shown) configured to control the pressure of the fermentation tank for safety consideration when operating. In some embodiments, the microorganisms or microbial culture 124 may be a chemo-autotrophic microorganism selected from the group consisting of the following genera:

Acetoanaerobioum sp.; Acetobacerium sp.; Acetogenium sp.; Achronobacater sp., Acidianus sp.; Acinetobacer sp.; Actinomadura sp.; Aeromonas sp.; Alcaligenes sp.; Alcaligenes sp.; Arcobacter sp.; Aureobacterium sp.; Bacillus sp.; Beggiatoa sp.; Butyribacterium sp.; Carboxydothermus sp.; Clostridium sp.; Comamonas sp.; Dehalobacter sp.; Dehalococcoide sp.; Dehalospirillum sp.; Desulfobacterium sp.; Desulfomonile sp.; Desulfotomaculum sp.; Desulfovibrio sp.; Desulfursarcina sp.; Ectothiorhodospira sp.; Enterobacter sp.; Eubacterium sp.; Ferroplasma sp.; Halothibacillus sp.; Hydrogenobacter sp.; Hydrogenomonas sp.; Leptospirillum sp.; Metallosphaera sp.; Methanobacterium sp.; Methanobrevibacter sp.; Methanococcus sp.; Methanosarcina sp.; Micrococcus sp.; Nitrobacter sp.; Nitrosococcus sp.; Nitrosolobus sp.; Nitrosomonas sp.; Nitrosospira sp.; Nitrosovibrio sp. Nitrospina sp.; Oleomonas sp.; Paracoccus sp.; Peptostreptococcus sp.; Planctomycetes sp.; Pseudomonas sp.; RalsOntia sp.; Rhodobacter sp.; Rhodococcus sp.; Rhodocyclus sp.; Rhodomicrobium sp.; Rhodopseudomonas sp.; Rhodospirillum sp.; Shewanella sp.; Streptomyces sp.; Sulfobacillus sp.; Sulfolobus sp.; Thiobacillus sp.; Thiomicrospira sp.; Thioploca sp.; Thiosphaera sp.; Thiothrix sp.; and combinations thereof.

In some embodiments, the fermentation tank 106 is arranged and configured to receive input O₂ gas 130 from either an internal component of the system 100 or external sources. It is noted that although the gas 114 transported to the fermentation tank 106 may contain O₂ that is originally from the aquacultural reservoir as described previously. In some embodiments, the O₂ from the gas 114 may be sufficient to meet the need for the cell cultivation in the fermentation tank 106. In embodiments when more O₂ is needed for the fermentation process, the input O₂ 130 could advantageously provide additional O₂ to the fermentation tank 106. The fermentation tank 106 is arranged and configured to mix the input H₂ 128, the input O₂ 130, and the gas 114 to form a combined gas 132 comprising H₂, O₂, and CO₂. In some embodiments, the controller 122 is arranged and configured to adjust the ratio of H₂/O₂/CO₂ of the combined gas 132 to a level or range desirable for promoting bacteria growth when operating.

The biomass 126 produced in the fermentation tank 106 according to some embodiments of the present disclosure may be grown as a chemostat culture giving a continuous output of cells. One way to harvest the biomass product is to centrifuge and filter water from the fermentation tank 106 through a filter with a pore size less than 0.2 micron, or alternatively by ultrafiltration by a molecular weight cutoff of about 20-50 KD. For ensuring the correct type of bacteria in subsequent batches, it will also be possible to use some of the isolated bacteria as a re-inoculating medium in subsequent fermentation or growth batches.

The resulted biomass 126 is a nutrition-rich biological media or cell culture, and contains primarily protein, and other ingredients including but not limited to growth factor, hormone, antibiotic, amino acid, peptide, vitamin, colorant, carotenoid, fatty acids, fat, and oil, carbohydrate, sugar, and minerals. In some embodiments, the biomass 126 has about 20% to about 50% by weight of protein, about 25% to about 60% of fatty acid/oil, about 5% to about 30% of minerals. The biomass 126 could be used directly or indirectly to feed the living organisms 110 in the aquacultural reservoir 102.

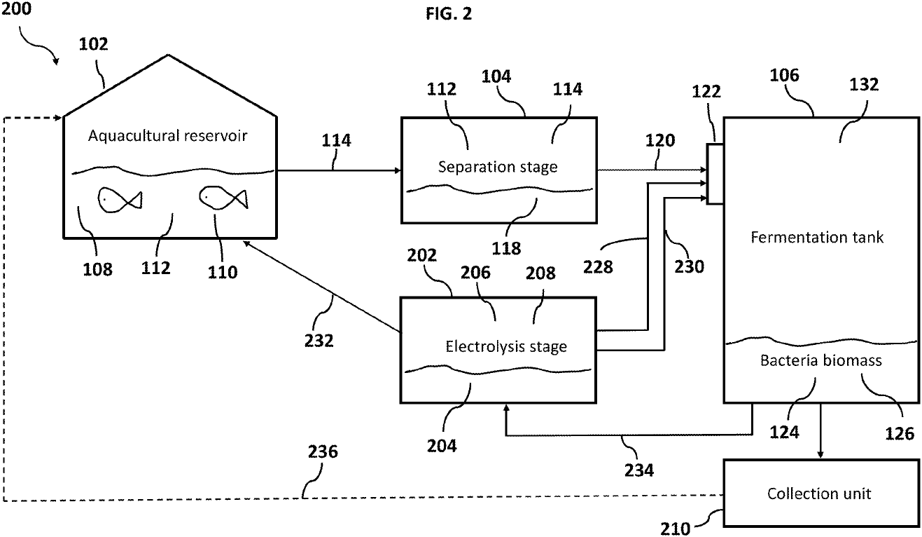

FIG. 2 is a schematic view of a second example system 200 for recycling and reusing biogenic CO₂. In the illustrated example, the system 200 includes an aquacultural reservoir 102, a separation stage 104, a fermentation tank 106, and one or more parts that are previously described in the system 100 as shown in FIG. 1. The system 200 further includes an electrolysis stage 202. The electrolysis stage 202 is arranged and configured to electrolyze water to produce gaseous O₂ 206, gaseous H₂ 208, and heated water 204 that can be used as supply for the system 200.

In some embodiments, the electrolysis stage 202 comprises an industrial electrolyzer that is configured to utilize renewable electrical energy such as electrical energy issued from solar panels, wind power plants, windmills, or conventional water-power plants for electricity. The electrolysis of water typically creates clean oxygen and hydrogen gases, in an amount of about 8 kg oxygen per kilogram of hydrogen gas. The electrolysis stage 202 is configured to automatically separate the produced oxygen and hydrogen gases, which can be respectively removed away from the electrolysis stage 202 through different outputs at substantially high purity. Electrolysis of water could automatically generate heated water at elevated temperatures, e.g., from about 30° C. to about 80° C. In some embodiments, a large amount of heated water 204 at about 40° C. could be produced in the electrolysis stage 202 during operation. Examples of electrolyzer are commercially available, such as products supplied by Hydrogen-pro, Norway (www.hydrogen-pro.com).

The fermentation tank 106 is arranged and configured to receive at least a portion of the H₂ gas 206 from the electrolysis stage 202. In some embodiments, the electrolysis stage 202 and the fermentation tank 106 are connected by one or more connecting lines 228, wherein the H₂ gas 206 can be transported through the connecting lines 228 to the fermentation tank 106. In some embodiments, one or more pumps (not shown) in connection to the connecting lines 228 can be used to facilitate the transportation of the H₂ gas 206. The flow rate of H₂ may be controlled by a gas mass meter/controller (not shown) commonly known in the art.

In some embodiments, the fermentation tank 106 is arranged and configured to receive at least a portion of the O₂ gas 208 from the electrolysis stage 202. Likewise, the electrolysis stage 202 and the fermentation tank 106 are connected by one or more connecting lines 230, wherein the O₂ gas 208 can be transported through the connecting lines 230 to the fermentation tank 106. In some embodiments, one or more pumps (not shown) in connection to the connecting lines 230 can be used to facilitate the transportation of the H₂ gas 208. The flow rate of O₂ may be controlled by a gas mass meter/controller (not shown) commonly known in the art.

The fermentation tank 106 is arranged and configured to mix the input H₂ 206 and the biogenic CO₂ 112, or alternatively, the input H₂ 206, the input O₂ 208, and the biogenic CO₂ 112, to form a combined gas 132 comprising either H₂ and CO₂ or H₂, O₂, and CO₂, respectively. In some embodiments, the controller 122 is arranged and configured to adjust the ratio of H₂/O₂ or the ratio of H₂/O₂/CO₂ of the combined gas 132 to a level or range desirable for promoting bacteria growth when operating.

The aquacultural reservoir 102 is arranged and configured to receive at least a portion of the O₂ gas 208 from the electrolysis stage 202. In some embodiments, the electrolysis stage 202 and the aquacultural reservoir 102 are connected by one or more connecting lines 232, wherein at least a portion of the O₂ gas 208 can be transported through the connecting lines 232 to the aquacultural reservoir 102. Particularly in a closed or substantially closed cultivation or breeding tank that is free from atmospheric O₂, it is important to supply external O₂ to spruce up the aquatic water 108 because the living organisms 110 therein need oxygen dissolved in the water for their energy/metabolism while producing biogenic CO₂ through such metabolism. The electrolysis stage 202 thus advantageously provides a source of O₂ to improve the living conditions in the aquacultural reservoir 102.

The present system is advantageous over the traditional aeration process. The O₂ 208 supplied to the aquacultural reservoir 102 is generated from the electrolysis stage 202 and is clean, fresh, with high purity and quality. In contrast, conventional aeration by blowing air into the aquatic water may not provide fresh and clean O₂ to the aquatic animals. In addition, blowing air into aquatic water may introduce extra N₂ gas or other unwanted materials, dirt, or contaminants, which may cause harm to the aquatic animals.

In some embodiments, the electrolysis stage 202 is arranged and configured to receive water produced by the fermentation tank 106. Bacteria cultivation in the fermentation tank 106 could generate water as a by-product, which upon separation or purification could be recycled as feed water for electrolysis. In one arrangement, the water produced in the fermentation tank is transported through one or more connecting lines 234 to the electrolysis stage 202 as a water source for electrolysis. In such arrangement, the biogenic CO₂, H₂, O₂, and water could circulate in the system 200, thereby significantly improving the total efficiency of the system 200 and reducing both cost and waste.

In some embodiments, the system 200 further includes a collection unit 210 arranged and configured to receive and store the produced biomass 126 from the fermentation tank 106. The collected biomass 126 could be further processed and then directly or indirectly used as a source of nutrition supply 236 to feed the living organisms 110 in the aquacultural reservoir 102. As such, biogenic CO₂ is substantially or completely recycled, resulting in recirculation of biogenic carbon in the system 200 without substantial emission of CO₂ to the external environment. In comparison to the system disclosed in WO 2018/070878, the systems disclosed herein advantageously bypass the intermediate step of producing methane/methanol and demonstrate a major improvement by providing a process that is more direct and twice as effective and therefore is able to produce 100% of biomass needed from biogenic CO₂ at lower cost. Further, all the captured carbon is recycled in the present systems, while the systems disclosed in WO 2018/070878 may lose about 50% carbon to air as CO₂.

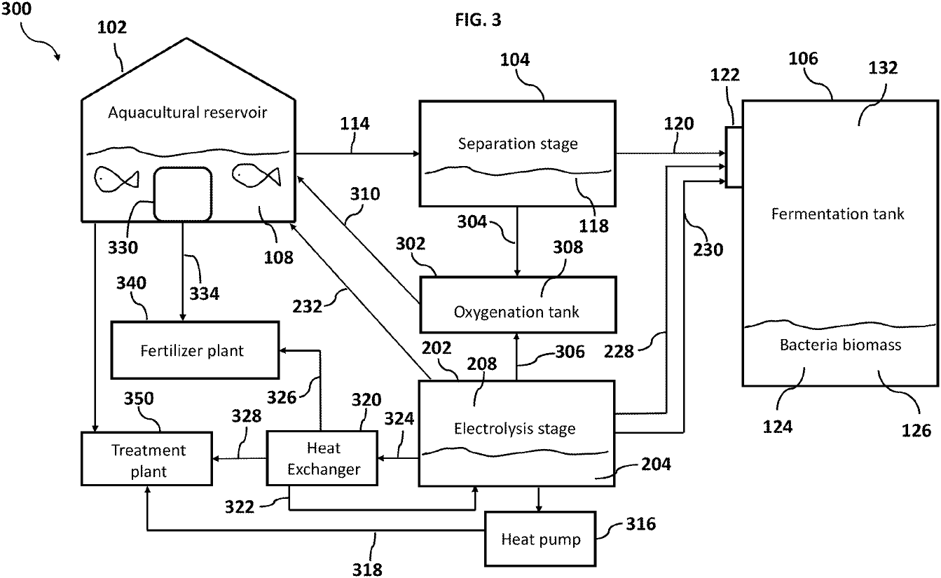

FIG. 3 is a schematic view of a third example system 300 for recycling and reusing biogenic CO₂. In the illustrated example, the system 300 includes an aquacultural reservoir 102, a separation stage 104, a fermentation tank 106, an electrolysis stage 202, and one or more parts that are previously described in the systems 100 or 200 as shown in FIGS. 1 and 2 respectively. The system 300 further includes an oxygenation tank 302. The oxygenation tank 302 is arranged and configured to receive the CO₂-poor water 118 generated from the separation stage 104 through one or more connecting lines 304, and to receive at least a portion of the O₂ 208 generated in the electrolysis stage 202 through one or more connecting lines 306. The oxygenation tank 302 is arranged and configured to oxygenate the received CO₂-poor water 118 using the received O₂ 208 to produce O₂-rich water 308. Techniques and methods for oxygenating water are generally known in the art.

In some embodiments, the aquacultural reservoir 102 is arranged and configured to receive the produced O₂-rich water 308 from the oxygenation tank 302 through one or more connecting lines 310. The O₂-rich water 308 is saturated with fresh O₂ in a dissolved or hydrated state that is more readily consumable by the aquatic animals comparing with gaseous O₂, and therefore more effectively sustains the living conditions and vitality thereof. As such, the aquatic water is capable of at least partially recirculating in the system 300.

In some embodiments, the system 300 includes a heat pump 316 in fluid communication with the electrolysis stage 202. The heat pump 316 is arranged and configured to receive the heated water 204 generated in the electrolysis stage 202 and convert the heated water into hot water or steam 318, which can be transported to other components of the system 300 or further used for other aquacultural purposes. In some embodiments, the system 300 includes a treatment plant 350. The hot water or steam 318 could be supplied to the treatment plant 350 for slaughtering fish, food processing, sanitation, production treatment of fish meat, etc. In some embodiments, the aquacultural reservoir 102 includes a biofilter arranged and configured to clean the aquatic water and filter out sludges, sediments, and wastes. The system 300 may include a fertilizer plant 340 arranged and configured to receive the sludge and waste from the aquacultural reservoir 102. The hot water or steam 318 may be supplied to the fertilizer plant 340 for drying the sludge. The sludge may also be used for producing fertilizer, biogas, and/or the isolation of phosphor or phosphorous compounds. The products of the fertilizer plant may be transported to other components of the system 300 as a source of self-sustained energy or alternatively be sold. Other uses of the hot water or steam 318 include but are not limited to: regulating the temperature of the separation stage 104 to facilitate more convenient extraction of CO₂ from the water therein; regulating the temperature of the aquatic water in the aquacultural reservoir 102; or drying the waste from the fish processing (bones, innards, fish heads, skin, etc.). Water isolated from the drying process may be returned to the electrolysis stage 202 for electrolysis of the water, thus providing an opportunity for an even more self-sustaining system for producing biomass.

In other embodiments, the system 300 includes a heat exchanger 320 arranged and configured to receive the heated water 204 generated in the electrolysis stage 202 through one or more connecting lines 324. The heat exchanger 320 is configured to extract heat energy from the heated water and generate cooled water. The extracted heat from the heat exchanger 320 could be transferred to other components of the system 300 for aquacultural purposes. As an exemplary example, the extracted heat can be transferred to the fertilizer plant 340 through line 326 to dry the sludge or process the waste therein. Additionally, the extracted heat could be transferred to the treatment plant 350 through line 328 to facilitate slaughtering and processes.

In some embodiments, the extracted heat energy may be transferred to the aquacultural reservoir 102 to regulate the temperature of the aquatic water 108 therein. It is known that cold water is better in assimilating the biogenic CO₂ compared with hot water. For example, water at a temperature of 60-90° C. carries far less entrained gas than water at e.g. 4-15° C. Additionally, environmental temperature may also affect the vitality of the living aquatic animals therein. Consequently, the temperature in the aquacultural reservoir 102 may be maintained at suitable levels to control the CO₂ content and the living environment thereof by using the extracted heat produced by the heat exchanger 320.

In other embodiments, the extracted heat energy may be used for other purposes including but not limited to: being transferred to the separation stage 104 to regulate the temperature thereof; being transferred to the fermentation tank 106 to regulate the temperature of the bacteria fermentation; being used to dry the produced biomass.

In some embodiments, the cooled water generated from the heat exchanger 320 could be transported back to the electrolysis stage 202 as feed water through one or more connecting lines 322, which allows the cooled water to be fully recycled and reused in the system 300.

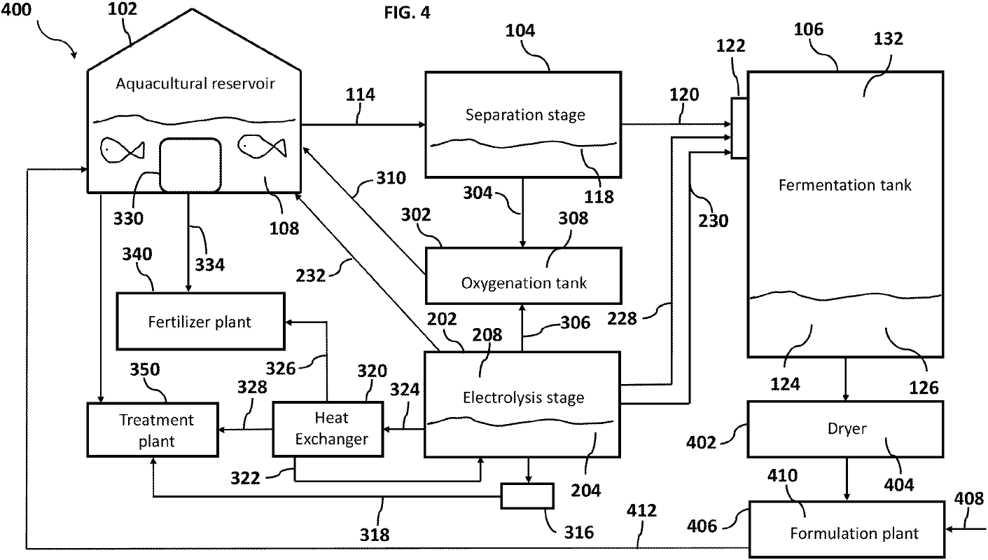

FIG. 4 is a schematic view of a fourth example system 400 for recycling and reusing biogenic CO₂. In the illustrated example, the system 400 is a closed fish farming plant having a aquacultural reservoir 102 that is closed or substantially closed, a separation stage 104, a fermentation tank 106, an electrolysis stage 202, an oxygenation tank 302, and one or more components that are previously described in the systems 100, 200, or 300 as shown in FIGS. 1-3. The system 400 additionally includes a dryer 402 arranged and configured to receive and dry the biomass 126 produced in the fermentation tank.

In some embodiments, the system 400 includes a formulation plant 406 arranged and configured to receive and process the dried biomass 404 produced in the dryer 402 to produce aquatic feed 410 that is finished or semi-finished. Additional ingredients 408 from external sources may be supplied to the formulation plant 406 to formulate the aquatic feed 410. The produced aquatic feed 410 could be supplied to the aquacultural reservoir 102 and used to feed the aquatic animals therein. As such, the closed system 400 may be substantially self-sustaining, which minimizes the emission of biogenic CO₂ and maximizes the efficiency of biomass production and utilization.

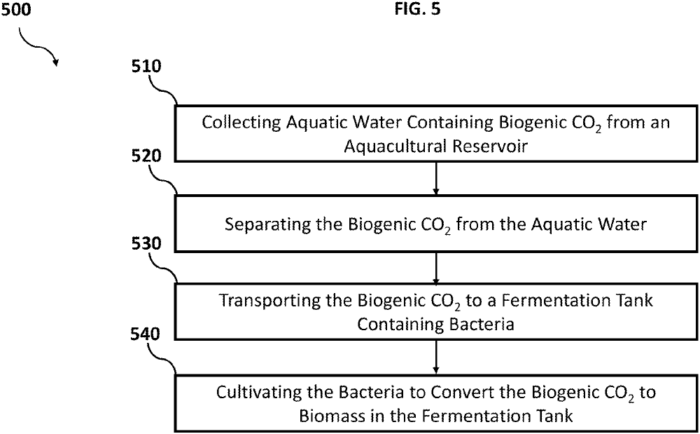

Now referring to FIGS. 5-9, exemplary examples of processes for recycling biogenic CO₂ will be described. FIG. 5 illustrates a flow diagram of a first example process 500 for recycling biogenic CO₂ in accordance with aspects of the system 100 and the components thereof described above. In the illustrated example, the process 500 includes operations 510, 520, 530, and 540. At 510, aquatic water from an aquacultural reservoir is collected, wherein the aquatic water contains CO₂ biogenically produced by aquatic animals and dissolved in the water. At 520, the collected aquatic water is subject to a separation process by which the biogenic CO₂ gas is extracted or sequestered from the aquatic water. Collection of the aquatic water and separation of the biogenic CO₂ from the water may be operated in the separation stage 104 described above. At 530, the extracted biogenic CO₂ gas is transported to a fermentation tank containing bacteria. At 540, the biogenic CO₂ gas is converted to beneficia biomass through fermentation or gas fermentation processes.

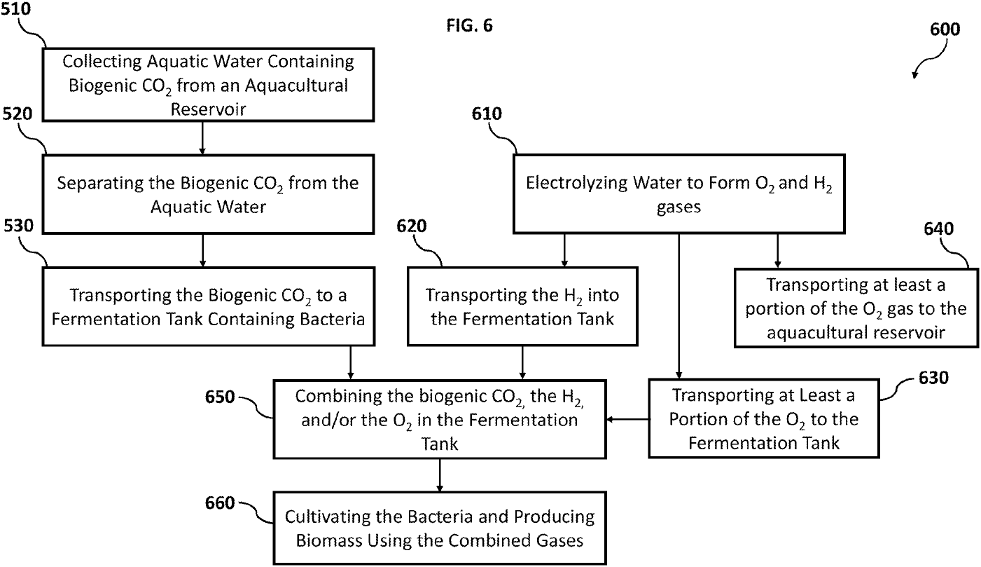

FIG. 6 illustrates a flow diagram of a second example process 600 for recycling biogenic CO₂ in accordance with aspects of the systems 100 and 200 and the components thereof described above. In the illustrated example, the process 600 includes operations 510, 520, and 530 as described above, and may additionally include one of more operations 610, 620, 630, 640, 650, and 660. At 610, water is electrolyzed to produce gaseous O₂ and H₂. Electrolysis of water may be operated in the electrolysis stage 202 described in the system 100. At 620, the produced H₂ gas is transported to the fermentation tank. At 630, at least a portion of the produced O₂ gas is transported to the fermentation tank. At 640, at least a portion of the produced O₂ gas is transported to the aquacultural reservoir for breeding the aquatic animals therein. At 650, the biogenic CO₂ gas received by 530, the H₂ gas received by 620, and/or the O₂ gas received by 630 are combined and mixed in the fermentation tank. In some embodiments, the process 600 may further include an operation to adjust the ratio of CO₂/H₂ or CO₂/H₂/O₂ to a desirable level for bacterial cultivation. The process 600 may also include an operation to adjust the pressure of the fermentation tank to appropriate levels for considerations of safety and productivity. At 660, biomass is produced by cultivating the bacteria in the fermentation tank and convert the combined CO₂/H₂ or CO₂/H₂/O₂ gases to biomass, according various aspects of the systems 100 or 200 described above.

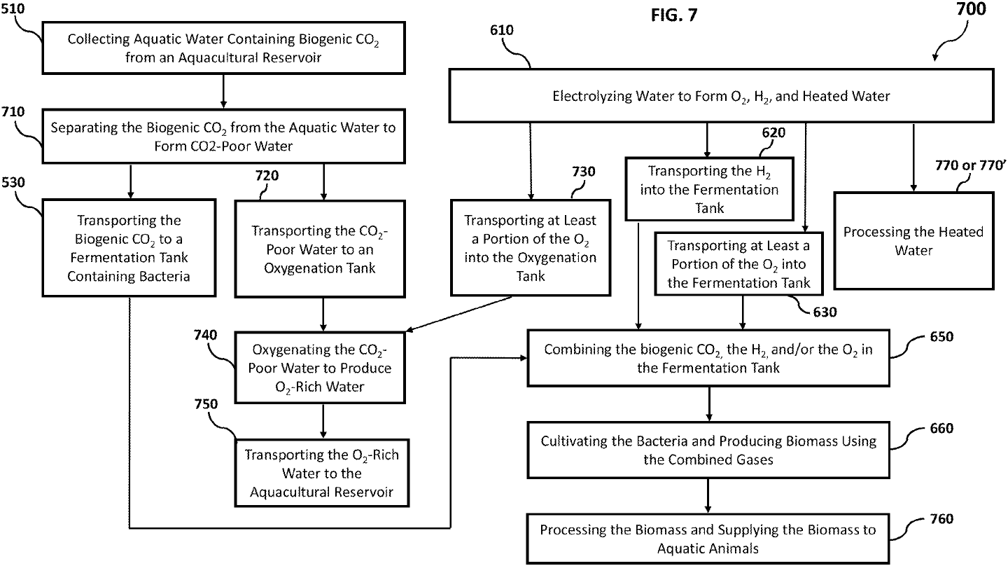

FIG. 7 illustrates a flow diagram of a third example process 700 for recycling biogenic CO₂ in accordance with aspects of the systems 300 and 400 and the components thereof described above. In the illustrated example, the process 700 includes operations 510, 530, 610, 620, 630, 650, and 660 as described above, and may additionally include one of more operations 710, 720, 730, 740, and 760. At 710, the aquatic water and the biogenic CO₂ dissolved therein are separated to form CO₂-poor water. The CO₂-poor water is subsequently oxygenated at 740 to produce oxygenated water that is O₂-rich. In some embodiments, oxygenation may be operated in the oxygenation tank 302 according to systems 300-400 previously described. At 730, at least a portion of the O₂ produced at 610 is transported into the oxygenation tank and used to oxygenate the CO₂-poor water. At 750, the O₂-rich water generated at 740 is transported to the aquacultural reservoir to sustain living conditions of aquatic animals. The O₂-rich water provides abundant fresh O₂ dissolved in water that is more directly consumable by the aquatic animals therein.

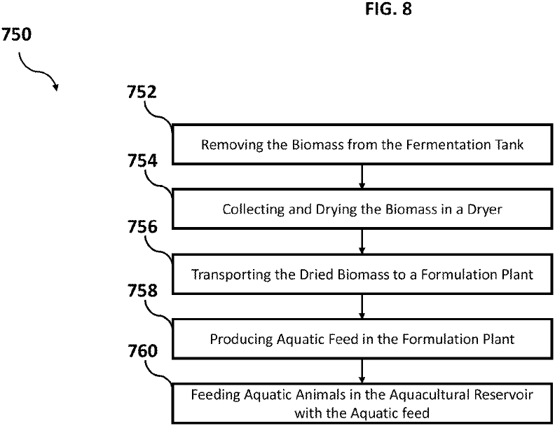

In some embodiments, the process 700 includes an operation 750 to process the biomass produced at 660 and supply the biomass to aquatic animals of the aquacultural reservoir. Now referring to FIG. 8, an exemplary example of the operation 750 is illustrated in accordance with aspects of the system 400 and the components thereof previously described. The operation 750 includes operations 752, 754, 756, 758, and 760. The produced biomass is removed at 752 from the fermentation tank; and collected and dried at 754 in a dryer. The dried biomass is transported at 754 to a formulation plant. Finished or semi-finished aquatic feed is produced at 754 by further formulating the dried biomass with optionally additional ingredients from external sources. The aquatic feed may be directly or indirectly used at 760 to feed the aquatic animals of the aquacultural reservoir. As such, the process 700 allows for substantially recycling and reusing the captured carbon from the biogenic CO₂ that is generated in the aquacultural reservoir.

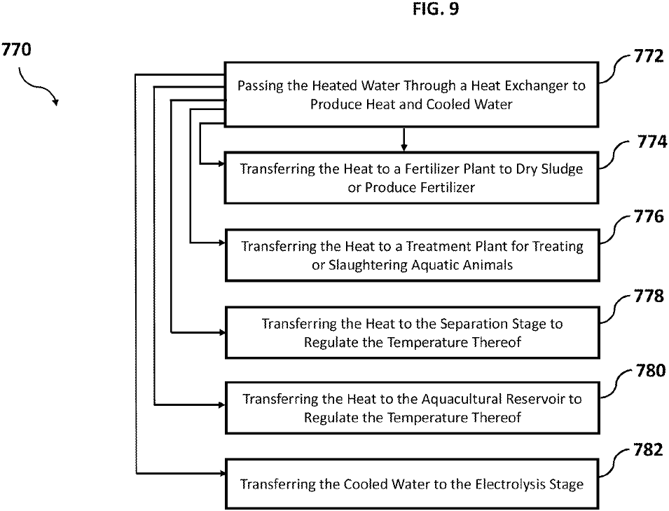

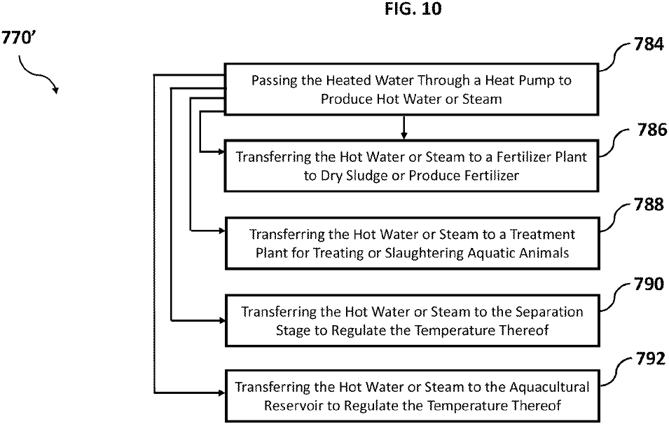

Now referring back to FIG. 7, in some embodiments, the process 700 includes an operation 770 or 770′ or both to process the heated water generated at 610. Examples of the operation 770 are illustrated in FIGS. 9-10. As an exemplary example shown in FIG. 9, the operation 770 includes operations 772, 774, 776, 778, 780, and 782. At 772, the heated water generated in the electrolysis of water is passed through a heat exchanger to extract heat from the heated water and produce a cooled water. The extracted heat energy could be used for various aquacultural purposes. In some embodiments, the heat is transferred at 774, to a fertilizer plant to dry sludge removed from the aquacultural reservoir and/or produce fertilizers from the dried sludge. At 776, the heat is transferred to a treatment plant for capturing, treating, and slaughtering the aquatic animals, processing meat, cleaning and sanitizing equipment, or other aquacultural uses. At 778, the heat is transferred to the separation stage to regulate the temperature thereof and/or facilitate extraction of biogenic CO₂ from the aquatic water. At 780, the heat is transferred to the aquacultural reservoir to regulate the temperature thereof. At 782, the cooled water produced at 772 can be transferred back to the electrolysis stage as feed water for electrolysis.

Now referring to FIG. 10, another exemplary example operation 770′ is illustrated in accordance with the process 700 and the system 400 previously described. In the illustrated example, the operation 770′ includes operations 784, 786, 788, 790, and 792. At 784, the heated water generated in the electrolysis of water is passed through a heat pump to further heat the water and produce hot water or steam at higher temperature. Similar to the operation 770, the hot water or steam of operation 770′ could be used for various aquacultural purposes. At 786, the hot water or steam is transferred to a fertilizer plant to dry sludge removed from the aquacultural reservoir and/or produce fertilizers from the dried sludge. At 788, the hot water or steam is transferred to a treatment plant for capturing, treating, and slaughtering the aquatic animals, processing meat, cleaning and sanitizing equipment, or other aquacultural uses. At 790, the hot water or steam is transferred to the separation stage to regulate the temperature thereof and/or facilitate extraction of biogenic CO₂ from the aquatic water. At 792, the hot water or steam is transferred to the aquacultural reservoir to regulate the temperature of the aquatic water therein.

The present systems and processes disclosed in this disclosure could be implemented into a fish farming plant. For such a fish farming plant, a typical example of the balance for the produced biomass is demonstrated as follows: a farming plant intended to cultivate about 1,000 ton per year of fish will need about 1,000 ton per year of feed; 1,000 ton per year of feed in turn requires a supply of about 350 ton per year of clean protein; 1,000 ton per year of fish biosynthetically produces about 1,200 ton per year biogenic CO₂ (based on a factor of 1.2) though metabolism. The fish farming plant employing the present system or process is expected to catch about 1,000 ton per year of the biogenic CO₂ (based on an estimated efficiency of 83%). Accordingly, the fish farming plant is expected to produce about 370 ton per year of clean and high-quality biomass containing primarily protein. Consequently, the expected production of about 370 ton per year of biomass protein meets the required 350 ton per year of protein for cultivating about 1,000 ton per year fish. In addition, the farming plant could also produce 53 ton per year of fatty acid as 13% of the biomass by weight. Thus, the fish farming plant employing the present systems or processes to recycle biogenic CO₂ and produce biomass may be self-sustaining.

The fish farming plant employing the present systems or processes is also expected to fully use the hydrogen and oxygen produced by electrolysis of water. Operably, the size of the electrolysis stage or the output of electrolysis products may be controlled or optimized to supply sufficient hydrogen to match the available biogenic CO₂. As an exemplary example, a fish farming plant employing the present systems or processes is intended to cultivate about 1,000 ton per year of fish, which requires about 1,100 ton per year of O₂ for producing biomass by fermentation and about 500 ton per year of O₂ for breeding fish. The fish farming plant may be designed to produce 1,900 ton per year of oxygen by electrolysis of water to meet the total requirement for O₂ (1,600 ton per year). The surplus of about 300 ton per year may partially cover losses and partially used as oversupply to the aquacultural reservoir, as highly recommended in the fish farming industry.

Moreover, production of 1,900 ton per year of oxygen provided above requires electrolysis of about 2,100 ton per year of clean water. Clean water may be supplied by using the water generated in the fermentation process according to the present disclosure. As an exemplary example, the fermentation tank may produce about 1,300 ton per year of water, some of which may be recycled to the fermentation tank; and some may be cleaned and transported to feed the electrolysis stage as water source. In one example, at least about 40% (or 840 ton per year) of the feedwater needed for electrolysis can be provided by the fermentation tank.

Further, production of 1,900 ton per year of oxygen by electrolysis of water generates heated water from which at least about 200 KW of heat energy can be extracted. The extracted heat energy can be supplied to other components where energy is needed for beneficial uses as previously described.

The fish farming plant employing the present systems or processes may advantageously reduce both capital and production expenses for biomass production, provide a continuous supply of O₂ and energy to the fish cultivation, and replace at least about 40% of the required fish feed.

The benefits of extensive recycling of resources provided by the present systems and processes can bring down the total production cost for biomass protein to make it competitive to current high-quality ecological feed. In combination with the fish farm IPU design (Independent Production Units) and a unique tracking system, the present systems or processes are much less expensive to construct and significantly cost-effective to operate, compared with the current standard land-based plants.

When introducing elements of the present disclosure or the various versions, embodiment(s) or aspects thereof, the articles “a”, “an,” “the,” and “said” are intended to mean that there are one or more elements. The terms “comprising,” “including,” and “having” are intended to be inclusive and mean that there may be additional elements other than the listed elements.

The term “about” is used here in conjunction with numeric values to include normal variations in measurements as expected by persons skilled in the art, and is understood to have the same meaning as “approximately” and to cover a typical margin of error, such as 15 % of the stated value.

The term “substantially free” may refer to any component that the subject matter of the present disclosure lacks or mostly lacks. Use of the term “substantially free” of a component allows for trace amounts of that component to be included in the subject matter of the disclosure. However, it is recognized that only de minimus amounts of a component will be allowed when the subject matter is said to be “substantially free” of that component. Moreover, it is understood that the component that is present in trace or de minimus amounts will not affect the effectiveness of the subject matter for intended uses.

“Fermentation” is defined as “a metabolic process that produces chemical changes in organic substrates through the action of enzymes. For the purposes of this disclosure, “fermentation” is a process for cultivating cells in a specialized containers, tanks, vessel, or reactors (made of glass, metal or plastic and known as a fermenter or fermentation tank or bio-reactor) under controlled process conditions in order to optimize their growth and maximize efficiency. The controlled process conditions include sterility, temperature, agitation rate, pH, input gas composition and flow rate, nutrient composition, cell density, dissolved gas concentration, biomass removal rate (for continuous or semi-continuous harvesting) and the like. Fermentation may be aerobic or anaerobic.

“Gas fermentation” refers to a fermentation in a fermentation tank or a bioreactor, wherein the metabolic processes of microorganisms or microbes or cells extract energy and carbon from the gaseous inputs that are supplied to them. Gas fermentation can refer to anaerobic or aerobic process of microbe cultivation on gases. By combining these gas inputs with the simple inorganic salts in the medium, chemo-autotrophic cells convert these basic inputs into more complex biomass and other cellular products. Gas fermentation can be either aerobic or anaerobic, depending on the organism used and the feedstock gases available for fermentation. Gas fermentation is a particularly advantageous form of chemo-autotrophic fermentation because the key inputs are provided by widely available gases such as CO₂, H₂, O₂, CH₄, etc.

“Cultivating” is defined as meaning “the act or process of culturing living material (such as bacteria or yeasts) in a prepared nutrient medium.” “Nutrient” is defined as meaning “a substance or ingredient that promotes growth, provides energy, and maintains life.” “Medium” is defined as “a nutrient system for the artificial cultivation of cells or organisms and especially bacteria.” Media can be liquid, semi-solid or solid (e.g., agar, beads, or other scaffolding). Solid or semi-solid media can provide a growth support for the cells.

“Heterotrophic” is defined as meaning “requiring complex organic compounds of nitrogen and carbon (such as that obtained from yeast, plant or animal matter) for metabolic synthesis.”

“Autotrophic” is defined as meaning “requiring only carbon dioxide or carbonates (C₁ compounds containing single carbon) as a source of carbon and a simple inorganic nitrogen compound for metabolic synthesis of organic molecules (such as glucose).”

“Chemo-autotrophic” is defined as “being auto trophic and oxidizing an inorganic compound as a source of energy.” The inorganic compound as a source of energy may include H₂, in the case of hydrogen-oxidizing microorganism, which can consume a combination of CO₂, H₂, and O₂. Examples include anaerobic acetogens that consume CO₂ for carbon and H₂ for energy. Chemoautotrophic metabolism is known in bacteria and archaea, and may also exist as an undiscovered trait, or as a capability conferred by genetic modification, in some other organisms. Examples of chemoautotrophs are found across numerous bacterial genera including but not limited to Cupriavidus, Rhodobacter, Methylobacterium, Methylococcus, Methylosinus, Nitrosomonas, Nitrosococcus, Nitrobacter, Nitrococcus, Paracoccus, Hydrogenothermus, Hydrogenovibrio, Clostridium, Rhodococcus, Rhodospirillum, Alcaligines, Rhodopseudomonas, and Thiobacillus, as well as in a number of genera of the archaea, including methanogens. Specific examples of chemoautotrophs include Cupriavidus necator, Cupriavidus basilensis, Rhodococcus opacus, Methylococcus capsulatus, Methylosinus trichosporium, Methylobacterium extorquens, Hydrogenothermus marinus, Rhodospirillium rubrum, Rhodopseudomonas palustrus, Paracoccus zeaxanthinifaciens, Rhodobacter sphaeroides, Rhodobacter capsulatus, and Clostridium autoethanogenum.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for recycling biogenic CO₂, the system comprising:
an aquacultural reservoir arranged and configured to contain water and aquatic animals that live therein;
a separation stage in fluid communication with the aquacultural reservoir, wherein the separation stage is arranged and configured to receive water from the aquacultural reservoir and separate gas from the water to generate a gas comprising biogenic CO₂, and CO₂-poor water; and
a fermentation tank in gas communication with the separation stage, wherein the fermentation tank is arranged and configured to receive the gas from the separation stage and cultivate bacteria by converting the biogenic CO₂ into biomass.

2. The system of claim 1 further comprising an electrolysis stage in gas communication with the fermentation tank, wherein the electrolysis stage is arranged and configured to electrolyze water to produce gaseous H₂ and O₂ and heated water therein, and wherein the fermentation tank is arranged and configured to:
receive at least a portion of the gaseous H₂ from the electrolysis stage;
combine the H₂ and the biogenic CO₂; and
cultivate bacteria by converting the combined gases to biomass.

3. The system of claim 2, wherein the fermentation tank is arranged and configured to:
receive at least a portion of the gaseous O₂ from the electrolysis stage;
combine the H₂, the O₂, and the biogenic CO₂; and
cultivate bacteria by converting the combined gases to biomass.

4. The system of claim 3, further comprising a controller configured to adjust the ratio of H₂/O₂/CO₂ being received by the fermentation tank.

5. The system of any one of claims 2-4, wherein the electrolysis stage is in gas communication with the aquacultural reservoir, and wherein the cultivation stage is arranged and configured to receive at least a portion of the O₂ from the electrolysis stage.

6. The system of any one of claims 2-5 further comprising an oxygenation tank in fluid communication with the separation stage and in gas communication with the electrolysis stage, wherein the oxygenation tank is arranged and configured to:
receive the CO₂-poor water from the separation stage;
receive at least a portion of the gaseous O₂ from the electrolysis stage; and
oxygenate the CO₂-poor water with the O₂ to form O₂-rich water.

7. The system of claim 6, wherein the oxygenation tank is in fluid communication with the aquacultural reservoir, and wherein the aquacultural reservoir is arranged and configured to receive the O₂-rich water from the oxygenation tank.

8. The system of any one of claims 2-7 further comprising a heat pump in fluid communication with the electrolysis stage, wherein the heat pump is arranged and configured to receive and heat the heated water from the electrolysis stage to produce hot water or steam.

9. The system of claim 8 further comprising a fertilizer plant arranged and configured to receive the hot water or steam produced by the heat pump, wherein the hot water or steam is used for drying sludge or producing fertilizer in the fertilizer plant.

10. The system of any one of claims 8-9 further comprising a treatment plant arranged and configured to receive the hot water or steam produced by the heat pump, wherein the hot water or steam is used for slaughtering, food processing, sanitation, and treatment of meat products in the treatment plant.

11. The system of any one of claims 2-10 further comprising a heat exchanger in fluid communication with the electrolysis stage, wherein the heat exchanger is arranged and configured to: receive the heated water from the electrolysis stage; extract the heat energy from the heated water; and produce cooled water.

12. The system of claim 11 further comprising a fertilizer plant arranged and configured to receive the extracted heat energy produced by the heat exchanger, wherein the heat energy is used for drying sludge or producing fertilizer in the fertilizer plant.

13. The system of any one of claims 11-12 further comprising a treatment plant arranged and configured to receive the extracted heat energy produced by the heat exchanger, wherein the heat energy is used for slaughtering, food processing, sanitation, and treatment of meat products in the treatment plant.

14. The system of any one of claims 11-13, wherein the heat energy is supplied to the aquacultural reservoir and used for regulating the temperature of the aquatic water therein.

15. The system of any one of claims 11-14, wherein the heat energy is supplied to the separation stage and used for regulating the temperature of the water therein.

16. The system of any one of claims 11-15, wherein the heat energy is supplied to the fermentation tank and used for regulating the temperature thereof.

17. The system of any one of claims 11-16, wherein the cooled water is recycled as feed water for electrolysis.

18. The system of any one of claims 1-17 further comprising a dryer configured to receive and dry the biomass produced in the fermentation tank.

19. The system of any one of claims 1-18 further comprising a formulation plant arranged and configured to produce aquatic feed using the biomass produced in the fermentation tank, and wherein the aquatic feed is used to feed aquatic animals in the aquacultural reservoir.

20. The system of any one of claims 2-19, wherein the electrolysis stage is in fluid communication with the fermentation tank, wherein the electrolysis stage is arranged and configured to receive and electrolyze water generated from the bacteria cultivation in the fermentation tank.

21. The system of any one of claims 1-20, wherein the aquacultural reservoir is a closed or substantially closed cultivation or breeding tank.

22. The system of any one of claims 1-21, wherein the aquatic animals in the aquacultural reservoir contains salmon.

23. The system of any one of claims 1-22, wherein the gas is separated from the water by ultrasound in the separation stage.

24. A process for recycling biogenic CO₂, the process comprising:
collecting aquatic water containing biogenic CO₂ from an aquacultural reservoir;
separating gas from the aquatic water in a separation stage to form a gas containing the biogenic CO₂, and CO₂-poor water;
transporting the gas to a fermentation tank containing bacteria; and
cultivating the bacteria by converting the biogenic CO₂ to biomass.

25. The process of claim 24 further comprising:
electrolyzing water to form gaseous O₂ and H₂ and heated water;
transporting at least a portion of the H₂ into the fermentation tank;
combing the H₂, and the biogenic CO₂ in the fermentation tank; and
cultivating the bacteria by converting the combined gases to biomass.

26. The process of claim 25 further comprising:
adjusting the ratio of the H₂ and the biogenic CO₂ being received in the fermentation tank.

27. The process of any one of claims 25-26 further comprising:
transporting at least of a portion of the O₂ into the fermentation tank;
combing the H₂, the O₂, and the biogenic CO₂ in the fermentation tank; and
cultivating the bacteria by converting the combined gases to biomass.

28. The process of claim 27 further comprising:
adjusting the ratio of the H₂, the O₂, and the biogenic CO₂ being received in the fermentation tank.

29. The process of any one of claims 25-28 further comprising:
transporting at least a portion of the O₂ gas to the aquacultural reservoir.

30. The process of any one of claims 25-29 further comprising:
transporting at least a portion of the O₂ gas into an oxygenation tank;
transporting the CO₂-poor water into the oxygenation tank;
mixing the O₂ and the CO₂-poor water thereby forming O₂-rich water; and
transporting the O₂-rich water into the aquacultural reservoir.

31. The process of any one of claims 25-30 further comprising transporting the heated water to a heat pump to produce hot water or steam.

32. The process of claim 31, wherein the hot water or steam is transferred to a fertilizer plant and used for drying sludge or producing fertilizer in the fertilizer plant.

33. The process of any one of claims 31-32, wherein the hot water or steam is transferred to a treatment plant and used for slaughtering, food processing, sanitation, and treatment of meat products in the treatment plant.

34. The process of any one of claims 25-33 further comprising transporting the heated water to a heat exchanger to extract the heat energy from the heated water and produce cooled water.

35. The process of claim 34, wherein the extracted heat energy is transferred to a fertilizer plant and used for drying sludge or producing fertilizer in the fertilizer plant.

36. The process of any one of claims 34-35, wherein the extracted heat energy is transferred to a treatment plant and used for slaughtering, food processing, sanitation, and treatment of meat products in the treatment plant.

37. The process of any one of claims 34-36, wherein the extracted heat energy is supplied to the aquacultural reservoir and used for regulating the temperature of the aquatic water therein.

38. The process of any one of claims 34-37, wherein the extracted heat energy is supplied to the separation stage and used for regulating the temperature of the water therein.

39. The process of any one of claims 34-38, wherein the extracted heat energy is supplied to the fermentation tank and used for regulating the temperature thereof.

40. The process of any one of claims 34-39, wherein the cooled water is recycled as feed water for electrolysis.

41. The process of any one of claims 24-40 further comprising:
removing the produced biomass from the fermentation plant;
collecting and drying the removed biomass in a dryer;
transporting the dried biomass into a formulation plant; and
producing aquatic feed using the dried biomass in the formulation plant.

42. The process of any one of claims 24-41 further comprising:
feeding aquatic animals in the aquacultural reservoir with the produced aquatic feed.

43. The process of any one of claims 24-42, wherein the gas is separated from the water by ultrasound in the separation stage.

44. A closed farming system comprising:
an aquacultural reservoir arranged and configured to contain water and aquatic animals that live therein;
a separation stage in fluid communication with the aquacultural reservoir, wherein the separation stage is arranged and configured to receive water from the aquacultural reservoir and to separate gas from the water by ultrasound to form a gas comprising biogenic CO₂, and CO₂-poor water;
an electrolysis stage arranged and configured to electrolyze water and to produce gaseous H₂ and O₂;
a fermentation tank in gas communication with the separation stage and the electrolysis stage, wherein the fermentation tank is arranged and configured to:
receive the gas from the separation stage, and at least a portion of the H₂ and at least a portion of the O₂ from the electrolysis stage;
combine the gases;
cultivate bacteria by converting the combined gases into biomass; and
a controller arranged and configured to adjust the ratio of H₂/O₂/CO₂ being received by the fermentation tank,
wherein the produced biomass is directly or indirectly used to feed aquatic animals in the aquacultural reservoir.

45. The system of claim 44, wherein the electrolysis stage is in gas communication with the aquacultural reservoir, and wherein the cultivation stage is arranged and configured to receive at least a portion of the O₂ from the electrolysis stage.

46. The system of any one of claims 44-45 further comprising an oxygenation tank respectively in fluid communication with the separation stage, in fluid communication with the aquacultural reservoir, and in gas communication with the electrolysis stage,
wherein the oxygenation tank is arranged and configured to:
receive the CO₂-poor water from the separation stage;
receive at least a portion of the gaseous O₂ from the electrolysis stage; and
oxygenate the CO₂-poor water with the O₂ to form O₂-rich water,
and wherein the aquacultural reservoir is arranged and configured to receive the O₂-rich water.

47. The system of any one of claims 44-46 further comprising a heat pump in fluid communication with the electrolysis stage, wherein the heat pump is arranged and configured to receive and heat the heated water from the electrolysis stage to produce hot water or steam.

48. The system of any one of claims 44-47 further comprising a heat exchanger in fluid communication with the electrolysis stage, wherein the heat exchanger is arranged and configured to receive the heated water from the electrolysis stage; extract the heat energy from the heated water; and produce cooled water.
